(19) United States
(12) Patent Application Publication
(10) Pub. No.: US 2025/0026180 A1
(43) Pub. Date: Jan. 23, 2025

(54) AIR FILTERING SYSTEM

(71) Applicants: MAHLE INTERNATIONAL GMBH, Stuttgart (DE); KARLSRUHER INSTITUT FÜR TECHNOLOGIE, Eggenstein-Leopoldschafen (DE)

(72) Inventors: Sven PETZNER, Welzheim (DE); Daniel EBERLE, Ludwigsburg (DE); Andrei BOLOGA, Stutensee (DE); Hans-Joachim GEHRMANN, Weingarten (DE)

(21) Appl. No.: 18/769,580

(22) Filed: Jul. 11, 2024

(30) Foreign Application Priority Data
Jul. 18, 2023 (DE) 102023206792.7

(51) Int. Cl. B60H 3/00; B03C 3/155; B03C 3/41; B03C 3/68; B60H 3/06

(52) U.S. Cl. CPC B60H 3/0071; B03C 3/155; B03C 3/41; B03C 3/68; B60H 3/06

(57) ABSTRACT

A filtering system for filtering air is provided, which contains a filter and an electrode assembly downstream of the filter that contains an electrode and a counter electrode for an ionizer, between which there is a voltage for generating a corona discharge when in operation. An improved and lasting filtering effect is obtained in that the counter electrode is connected electrically to the filter in the reactivation mode. An air conditioner and a vehicle that has such a filtering system.

### CROSS-REFERENCE TO RELATED APPLICATIONS

This application claims priority from German Patent Application No. DE 102023206792.7, filed on Jul. 18, 2023, the entirety of which is hereby fully incorporated by reference herein.

The present invention relates to a system for filtering air, in particular in a vehicle. The invention also relates to an air conditioner and a vehicle that contains such an air filtering system.

There are many reasons to filter air. This is often done with filtering systems. The air flows through the filter, which removes particles such as dust, thus purifying it.

Many air filters have an ionizer.

A filtering system of this type is disclosed in EP 3 488 933 A1. The filtering system contains an ionizer upstream of a filter that has an electrode and a counter electrode. The filter is between two other electrodes that are downstream of the ionizer. Voltages of opposite polarities are applied to the electrode and counter electrode in the ionizer and the electrodes between which the filter is placed.

The object of the present invention is to create a better, or at least a different, embodiment of such an air filter for an air conditioner and a vehicle, which has a long service life in particular.

This is achieved with the subject matter of the independent claims. Advantageous embodiments are the subject matter of the dependent claims.

The present invention is based on the idea of generating an electrostatic charge in the filter in a filtering system that has a filter and an ionizer upstream of the filter by electrically connecting the filter to a counter electrode in the ionizer. The invention acknowledges that the electrical connection of the filter to the counter electrode results in an electrostatic buildup of charge carriers in the filter medium, also referred to below as filter charge carriers, which results in a better and longer-lasting filtering of particles out of the air in a synergetic interaction with charge carriers generated by the ionizer, also referred to below as air charge carriers, which include ionized particles in the air in particular. This electrostatic buildup in the filter does not need to take place continuously, such that the electrical connection between the filter and the counter electrode is only used for the electrostatic buildup of filter charge carriers, also referred to below as reactivation. Consequently, with a simplified operation of the filtering system, a long-lasting, better filtering effect is obtained.

In accordance with the concept of the invention, the filtering system contains a filter for filtering particles out of the air. A flow path for the air passes through the filter. The filtering system also contains an ionizer. The ionizer contains an electrode assembly through which the flow path passes upstream of the filter. The electrode assembly contains an electrode that has at least one emitter, and a counter electrode, between which there is a voltage that results in a corona discharge in the air. The filter contains at least one electrically conductive section and at least one dielectric section. The at least one electrically conductive section is also referred to below as the conductive section, and the at least one dielectric section is also referred to below as the static section. The filter therefore contains at least one conductive section and at least one static section. The at least one conductive section and at least one static section are arranged successively along the flow path. In a first operating mode, at least one of the conductive sections, advantageously the respective conductive section, is electrically connected to the counter electrode, but disconnected therefrom in a second operating mode. The second operating mode is also referred to below as the regular operating mode, and the first operating mode is referred to below as the reactivation mode. The filtering system also contains a control unit for operating it. The control unit is therefore designed to operate the filtering system in the regular operating mode and in the reactivation mode successively. At least one of the conductive sections, in particular the respective conductive section, is connected to the counter electrode in the reactivation mode, but disconnected therefrom in the regular operating mode.

The filter is preferably electrostatically charged in advance, in particular prior to the first use thereof in the filtering system. In the reactivation mode, a recharging takes place at times, because the charge can diminish when the filtering system is in operation, i.e. in the regular operating mode. This means that the electrostatic charge is at least occasionally reactivated in the reactivation mode.

When the ionizer is in operation, the emitter emits electrons. This means that electrons from the emitter can travel through the air to the filter, thus reactivating it, in the reactivation mode.

The emitter is preferably a spike or needle.

The filter can have any design that filters particles, and preferably odors, out of the air, and has the at least one conductive section and the at least one static section.

By way of example, the at least one static section can be made of, or contain fibers.

By way of example, the at least one conductive section can be made of, or contain activated carbon.

The static section and conductive section can form layers in the filter. This means that the conductive section is an electrically conductive layer and the static section is a dielectric layer in the filter. This results in an improved flow through the filter, and better filtering.

The filtering system filters air and can be used in numerous applications.

The air filtering system can be used, for example, in an air conditioner, in particular an HVAC system, i.e. a “heating, ventilating, and air conditioning” system.

The air conditioner preferably has at least one heat exchanger through which air flows to transfer heat from the air to the heat exchanger, or vice versa.

The air filtering system is used in particular in a vehicle. It is preferably used to filter air supplied to the interior of the vehicle. This air filtering system can be part of such an air conditioner.

Voltage in the kilovolt range is applied between the electrode and the counter electrode to obtain a corona discharge. By way of example, the voltage is between 5 kV and 11 kV, in particular 8 kV.

The filtering system preferably has a power source that supplies the voltage between the electrode and the counter electrode. The electrode and counter electrode are electrically connected to different poles of the power source.

In preferred embodiments, the electrical connection of the counter electrode to the at least one conductive section is obtained with the power source. This results in not only more reliable operation, but also a simple implementation. When the ionizer is in operation, the electrode is connected to a first pole, in particular the negative pole, of the power source, and the counter electrode is connected to a second pole, in particular a counter-pole, and thus a counter-potential of the power source. The control unit is designed to electrically connect at least one of the conductive sections with the second pole in the power source, such that the at least one conductive section and the counter electrode are electrically connected to the power source in the reactivation mode. The control unit is also designed to disconnect the electrical connection to the second pole in the regular operating mode.

The “poles” in the present sense are those advantageously provided by the power source that are obtained due to a potential difference. This means that the counter-pole can also be the ground.

Embodiments generating a negative corona discharge when the ionizer is in operation are preferred. A negative corona discharge is preferably generated in both the regular operating mode and in the reactivation mode. The electrode, in particular the at least one emitter, has a negative polarity, and the counter electrode forms the counter-potential.

The at least one conductive section and at least one static section can be arranged in any sequence along the flow path.

Embodiments are preferred in which the at least one conductive section is downstream of the at least one static section. This means that there is at least one static section in the flow path between each conductive section and the electrode assembly. This results in a better reactivation in the reactivation mode.

The electrical connection between the counter electrode and the filter is obtained in preferred variants with an electric line. This means that an electric line connects the counter electrode to at least one of the conductive sections, advantageously the respective conductive section, preferably through the second pole in the power source. This electrical connection can be disconnected by a switch in the filtering system. The control unit switches the switch off in the regular operating mode, and on in the reactivation mode. The control unit is designed for this. When the switch is off, the electrical connection between the counter electrode and the at least one conductive section is disconnected, and connected when the switch is on. This results in a simple and reliable implementation of the operating modes.

The control unit can be designed in any way that allows a selection of the respective operating modes and switching between the regular operating mode and the reactivation mode.

The regular operating mode preferably lasts significantly longer than the reactivation mode. This prevents excessive electrostatic charging of the filter, and therefore repulsion of air charge carriers by the filter. This improves the filtering effect.

The reactivation mode advantageously lasts between 1 and 10 minutes. This means that the filtering system is operated in the reactivation mode for 1 to 10 minutes at a time. By way of example, the reactivation mode can last 2 to 5 minutes, in particular 5 minutes.

By way of example, the control unit can be designed such that the regular operating mode is at least ten times as long as the reactivation mode.

It is conceivable to switch between the regular operating mode and the reactivation mode in predefined intervals. The control unit is therefore designed to switch between the regular operating mode and the reactivation mode at predefined intervals. The control unit can contain a timer for this. The length of the regular operating mode is preferably longer than that of the reactivation mode.

It is also conceivable to switch between the regular operating mode and the reactivation mode when the air quality downstream of the filter is inadequate. The filtering system contains a sensor system that measures the air quality downstream of the filter in preferred embodiments. The control unit is connected to the sensor system and designed to switch from the regular operating mode to the reactivation mode when the measurement value obtained with the sensor system falls below a predefined threshold value.

The measurement value relates in particular to the dust content and/or particulate content in the air. The sensor system can therefore contain a dust sensor and/or particulate sensor.

The at least one emitter and the filter are advantageously spaced apart along the flow path at a distance of 0 mm to 30 mm, in particular 7 mm. The distance between the foremost static section, facing the emitter, and the at least one emitter is between 0 mm and 30 mm, in particular 7 mm, along the flow path. This results in an effective and rapid reactivation with sufficient reliability in the reactivation mode. This consequently results in better filtering effects with sufficient reliability.

The emitter can protrude toward the counter electrode or the filter.

The electrodes can contain rods that are spaced apart in the direction transverse to the flow path, from which at least one emitter protrudes, preferably toward the counter electrode. The rods are advantageously at a distance of 20 mm to 60 mm, e.g. 30 mm, to one another.

There are at least two emitters in particular that protrude from the respective rods, which are spaced apart in the direction transverse to the flow path and the direction that the rods are spaced apart, extending toward the filter and/or the counter electrode. The distance between the emitters on a rod is advantageously between 10 mm and 30 mm, e.g. 20 mm.

The electrode, in particular the emitter, on a respective rod is advantageously highly conductive and preferably made of stainless steel.

The counter electrode can basically have any design. The counter electrode is advantageously highly conductive and is made of stainless steel, for example.

Air can advantageously flow through the counter electrode. The flow path therefore passes through the counter electrode. This results in an better generation of air charge carriers.

In preferred embodiments, the counter electrode has a conductive grid, or is a conductive grid in particular, through which the flow path passes. This results in a lower flow resistance in the filtering system. This makes it possible to operate the filtering system more effectively, and to obtain a more compact design.

The grid preferably has a mesh size of 1 mm to 6 mm, e.g. 3 mm.

It is understood that in addition to the filtering system, the air conditioner and the vehicle containing the filtering system as such also belong to the scope of this invention.

Further features and advantages of the invention can be derived from the dependent claims, drawings, and descriptions in reference to the drawings.

It is understood that the features specified above and described below can be used not only in the given combinations but also in other combinations or in and of themselves without abandoning the framework of the present invention.

Preferred exemplary embodiments of the invention are shown in the drawings, an shall be explained below in greater detail, in which the same reference symbols are used for identical, similar, or functionally identical components.

Therein, schematically:

FIG. 1 shows a highly simplified circuit diagram of a filtering system in an air conditioner for a vehicle,

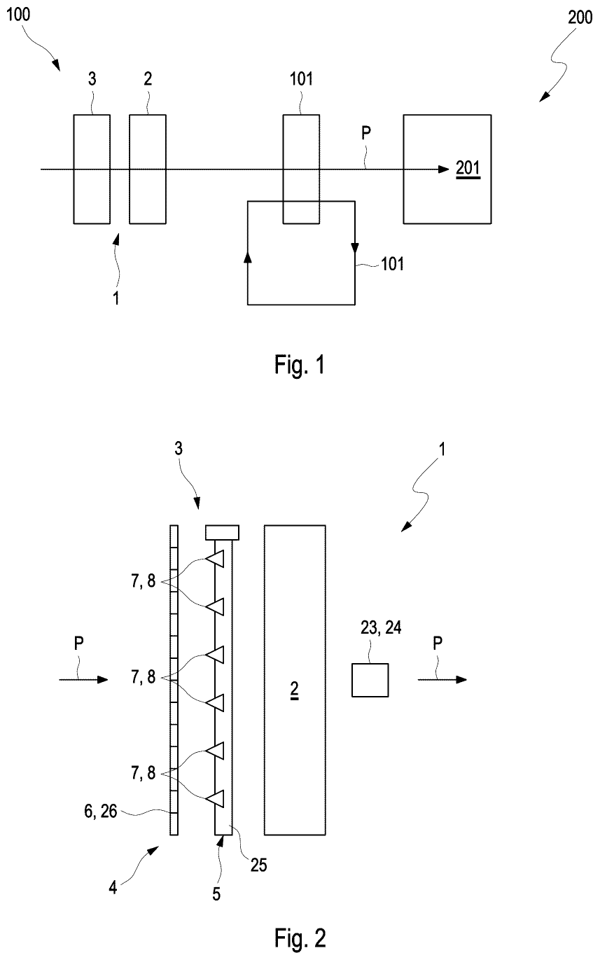

FIG. 2 shows a simplified sectional view of the filtering system,

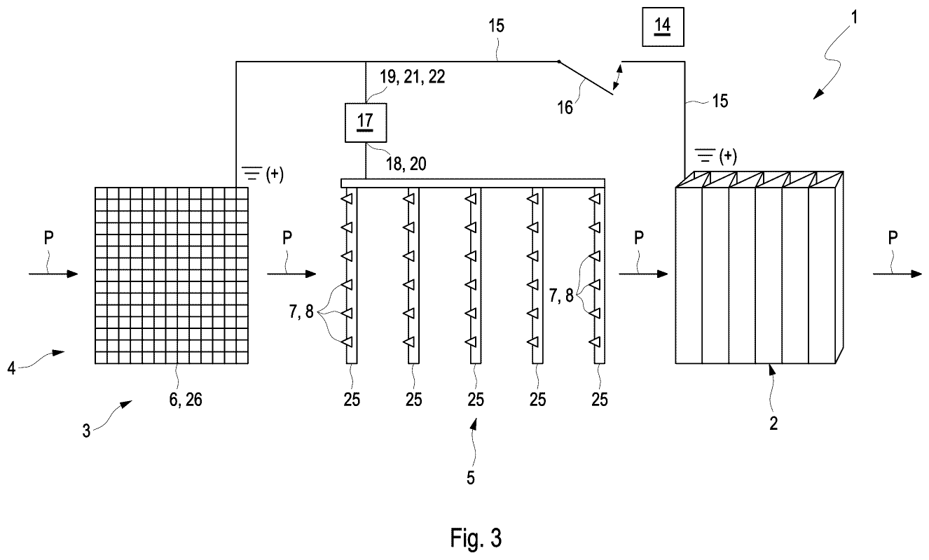

FIG. 3 shows an isometric, exploded view of the filtering system with a circuit diagram-type illustration of the electrical connections, and

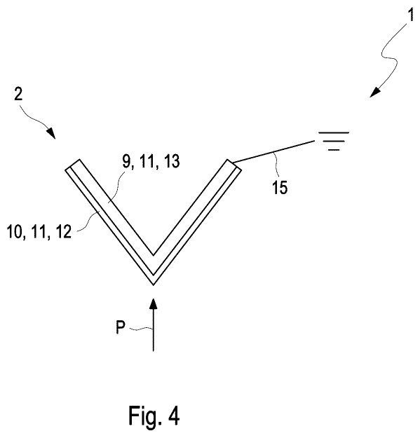

FIG. 4 shows a detail of a filter for the filtering system.

A filtering system 1 such as that shown in FIGS. 1 to 4 is used to filter air. A flow path P for the air passes through the filtering system 1 for this. The filtering system 1 can be used in an air conditioner 100 and/or a vehicle 200, as shown in FIG. 1. The vehicle 200 can contain the air conditioner 100. The air flows into the interior 201 of the vehicle 100 after flowing through the filtering system 1. The interior 201 is therefore downstream of the filtering system 1. The air conditioner 100 contains at least one heat exchanger 101 for exchanging heat with the air. The flow path P therefore passes through the heat exchanger 101. Only one heat exchanger 101 in the air conditioner 100 is visible in FIG. 1, which is downstream of the filtering system 1, merely by way of example. The air conditioner 100 can also contain numerous heat exchangers 101. At least one of the heat exchangers 101 is integrated in a circuit 102 indicated in FIG. 1, through which a fluid, e.g. a refrigerant or coolant, circulates, separately from the air, when the air conditioner 100 is in operation.

The filtering system 1 contains a filter 2 for removing particles from the air, as can be seen in particular in FIGS. 2 and 3. The flow path P for the air flows through the filter 2. The air flows through the filter 2, which filters particles such as dust and particulates out of the air. The filter 2 preferably also filters odors out of the air. The filter 2 is designed for this. The filter 2 is preferably electrostatically charged when it is new, thus containing charge carriers (not shown), which are also referred to below as filter charge carriers. The filtering system 1 also contains an ionizer 3 for generating a corona discharge in the air with which molecules and particles in the air are charged and ionized. Charge carriers are therefore generated in the air by the ionizer 3, which are also referred to below as air charge carriers. The ionizer 3 contains an assembly 4 made of electrodes 5, 6 for the corona discharge, which is also referred to below as a an electrode assembly 4. The electrode assembly 4 therefore has electrodes 5, 6 of different polarities, which are also referred to below as the electrode 5 and counter electrode 6, for purposes of clarity. There is therefore a voltage between the electrode 5 and the counter electrode when in operation, for generating the corona discharge, e.g. of a few kV. The flow path P passes through the electrode assembly 4 upstream of the filter 2. The electrode 5 has an emitter 7 that emits electrodes when the ionizer is in operation. The emitters 7 in the exemplary embodiments shown in the drawings are formed by spikes 8. The emitters 7 protrude toward the filter 2 or the counter electrode 6. The electrodes 5 and counter electrodes 6 are made of stainless steel in these exemplary embodiments. FIG. 4 shows a detail of the filter. It can be seen that the filter 2 contains at least one electrically conductive section 9, also referred to below as a conductive section 9, and at least one dielectric section 10, also referred to below as a static section 10, which are arranged sequentially along the flow path P. It is assumed in FIG. 4, purely by way of example and for purposes of simplicity, that the filter 2 contains one static section 10 and one conductive section 9. The static section 10 and the conductive section 9 each form a layer 11 in the exemplary embodiments shown here. There at least one conductive section 9 is downstream of the at least one static section 10 in these exemplary embodiments. This means that the static section 10 is upstream of the conductive section 9 in these exemplary embodiments.

As can also be seen in FIG. 4, the filter 2 in the exemplary embodiments shown in the drawings is a folded filter 2, in which the layers 11 are folded. The static section 10 is made of fibers 12, i.e. a layer 11 of fibers 12 in these exemplary embodiments. The conductive section 9 is made of activated carbon 13, i.e. a layer 11 of activated carbon 13 in these exemplary embodiments.

As shall be explained below, it is possible to obtain and disconnect an electrical connection between the counter electrode 6 and the conductive section 9 with the filtering system 1. This is obtained with the control unit 14 shown in FIG. 3. The conductive section 9 is electrically connected to the counter electrode 6 in the first operating mode. The conductive section 9 is disconnected from the counter electrode 6 in the second operating mode. The second operating mode is also referred to as the regular operating mode below, and the first operating mode is referred to as the reactivation mode. Charge carriers, in particular electrons emitted from the at least one emitter 7, are transferred to the filter 2 in the reactivation mode. This restores the electrostatic charge in the filter 2, which becomes weaker while the filtering system 1 is in operation. The filtering system 1 is subsequently operated in the regular operating mode again. The filtering system 1 is therefore operated successively, in particular alternating, in the regular operating mode and the reactivation mode. The operation in the reactivation mode lasts advantageously less than 10 minutes, e.g. between 1 minute and 10 minutes. The regular operating mode is advantageously substantially longer than the reactivation mode. By way of example, the regular operating mode lasts at least ten times as long as the reactivation mode.

The electrical connection between the conductive section 9 and the counter electrode 6 is obtained with an electric line 15, shown in FIG. 3 and indicated in FIG. 4. The electrical connection can be switched on and off by the switch 16 shown in FIG. 3. The switch is in the line 15 in FIG. 3, merely by way of example. The switch 16 is on in the reactivation mode, such that the counter electrode 6 and conductive section 9 are connected to one another by the line 15. The switch 16 is off in the regular operating mode, such that the counter electrode 6 is no longer electrically connected to the conductive section 9. FIG. 3 shows the switch 16 when it is off, and therefore in the regular operating mode. The control unit 14 is connected to the switch 16 and designed such that it is off in the regular operating mode and on in the reactivation mode, as indicated by the double arrow in FIG. 3.

As can be seen in FIG. 3, the filtering system 1 contains a power source 17 in the exemplary embodiments shown here, with which the voltage between the electrode 5 and counter electrode 6 is generated. The power source 17 has a first pole 18 and second pole 19 for generating the voltage. The first pole 18 in these exemplary embodiments is a negative pole 20 for the power source 17. The second pole 19 is a counter-pole 21, thus forming a counter-potential to the negative pole 20, in particular a grounded pole 22. This results in a negative corona discharge in the air when the ionizer 3 is in operation, both in the regular operating mode and in the reactivation mode.

As FIG. 3 also shows, the counter electrode 6 is electrically connected to the conductive section 9 by the power source 17 in these exemplary embodiments. The line 15 electrically connects the second pole 19 to the conductive section 9 for this, thus also connecting the conductive section 9 to the counter electrode 6. The switch 16 can be placed for this between the second pole 19 and the conductive section 9 in the line 15, as indicated in FIG. 3. In the regular operating mode, the conductive section 9 is disconnected from the second pole 19, such that the conductive section 9 is also disconnected from the counter electrode 6.

Switching between the regular operating mode and the reactivation mode can take place at predefined intervals. The control unit 14 is designed for this.

The filtering system 1 can contain a sensor system 23, shown in FIG. 2. The sensor system 23 measures the air quality. The sensor system 23 in these exemplary embodiments contains a particulate sensor 24. The measurement value therefore indicates or contains the particulate content in the in the air downstream of the filter 2. Switching from the regular operating mode to the reactivation mode takes place when the measurement value falls below a predefined threshold value, in particular when the particulate content exceeds a predefined value. The reactivation mode is advantageously maintained for the length described above, and then switched to the regular operating mode. The control unit 14 is designed for this. The control unit 14 is connected to the sensor system 23 for this.

FIG. 3 shows that the electrodes 5 in this exemplary embodiment have rods 22 that are spaced apart in the direction transverse to the flow path, from which emitters 7 protrude toward the counter electrodes 6. Purely by way of example, the electrodes 5 contain five such rods 22, each of which has six emitters 7 in this exemplary embodiment. The rods 22 and the emitters 7 are identical in this exemplary embodiment. The distance between successive rods 22 can be 20 mm to 60 mm, e.g. 30 mm. The distance between the successive emitters 7 along the respective rods 22 can be between 10 mm and 30 mm, e.g. 20 mm.

As FIG. 2 in particular shows, the emitters 7 are spaced apart from the filter 2. The distance between at least one emitter 7, preferably the respective emitter 7, and the filter 2, preferably the static section 10, along the flow path P is preferably between 0 mm and 30 mm, e.g. 7 mm.

FIG. 3 shows in particular that the counter electrodes 6 in the exemplary embodiments shown here form a grid 23 through which the flow path P passes.

The specification can be readily understood with reference to the following Representative Paragraphs:

Representative Paragraph 1. A filtering system (1) for filtering air, in particular for a vehicle (200), containing
a filter (2) for filtering particles out of the air, through which a flow path (P) for the air passes,
an ionizer (3), which contains an electrode assembly (4), through which the flow path (P) passes upstream of the filter (2),
wherein the electrode assembly (4) contains an electrode (5) that has at least one emitter (7) and a counter electrode (6), between which there is a voltage for generating a corona discharge in the air, when in operation,
wherein the filter (2) contains at least one electrically conductive section (9) and at least one dielectric section (10), which are arranged successively along the flow path (P),
with a control unit (14) designed to operate the filtering system (1) successively in a regular operating mode and a reactivation mode,
wherein at least one of the conductive sections (9), in particular the respective conductive section (9), is electrically connected to the counter electrode (6) in the reactivation mode, and disconnected therefrom in the regular operating mode.

Representative Paragraph 2. The filtering system according to Representative Paragraph 1, characterized in that
the filtering system (1) contains a power source (17) that supplies electricity between the electrode (5) and counter electrode (6),
when the ionizer (3) is in operation, the electrode (6) is connected to a first pole (18), in particular a negative pole (20), of the power source (17), and the counter electrode (6) is connected to a second pole (19) a counter-pole (21) of the power source (17),
the control unit (14) is designed such that in the reactivation mode at least one of the conductive sections (9) is electrically connected to the second pole (19) of the power source (9), such that the at least one conductive sections (9) and the counter electrode (6) are electrically connected by the power source (17), and is disconnected from the second pole (19) in the regular operating mode.

Representative Paragraph 3. The filtering system according to Representative Paragraph 1 or 2, characterized in that the at least one conductive section (9) is downstream of at least one static section (10).

Representative Paragraph 4. The filtering system according to any of the Representative Paragraphs 1 to 3, characterized in that the control unit (14) is designed such that the regular operating mode lasts at least ten time as long as the reactivation mode.

Representative Paragraph 5. The filtering system according to any of the Representative Paragraphs 1 to 4, characterized in that the control unit (14) is designed to switch between the regular operating mode and the reactivation mode at predefined intervals.

Representative Paragraph 6. The filtering system according to any of the Representative Paragraphs 1 to 5, characterized in that
the filtering system (1) contains a sensor system (23) downstream of the filter (2) for determining the air quality,
the control unit (14) is connected to the sensor system (23) and designed to switch from the regular operating mode to the reactivation mode if the value obtained from the sensor system (23) falls below a predefined threshold.

Representative Paragraph 7. The filtering system according to any of the Representative Paragraphs 1 to 6, characterized in that
an electric line (15) connects the counter electrode (6) to at least one of the conductive sections (9), in particular through the second pole (19) according to Representative Paragraph 2,
the filtering system (1) contains a switch (16) for electrically connecting and disconnecting the counter electrode (6) to the filter (2) with the line (15),
the control unit (14) is designed to switch the switch (16) off in the regular operating mode, and on in the reactivation mode.

Representative Paragraph 8. The filtering system according to any of the Representative Paragraphs 1 to 7, characterized in that the electrode (5) has a negative polarity in the regular operating mode and in the reactivation mode, and the counter electrode (6) forms the counter-potential.

Representative Paragraph 9. The filtering system according to any of the Representative Paragraphs 1 to 8, characterized in that the at least one emitter (7) and the filter (2) are spaced apart, wherein the distance between the at least one emitter (7) and the filter (2) along the flow path (P) is between 0 mm and 30 mm, in particular 7 mm.

Representative Paragraph 10. The filtering system according to any of the Representative Paragraphs 1 to 9, characterized in that the electrode (5) has rods (25) that are spaced apart along the flow path (p), each of which has at least one emitter (7) that protrudes therefrom.

Representative Paragraph 11. The filtering system according to any of the Representative Paragraphs 1 to 10, characterized in that the counter electrode (6) contains an electrically conductive grid (26) through which the flow path (P) passes.

Representative Paragraph 12. The filtering system according to any of the Representative Paragraphs 1 to 11, characterized in that the reactivation mode lasts between 1 and 10 minutes.

Representative Paragraph 13. The filtering system according to any of the Representative Paragraphs 1 to 12, characterized in that the static section (10) and conductive section (9) each form a layer (11) in the filter (2).

Representative Paragraph 14. An air conditioner (100), in particular for a vehicle (200), through which a flow path (P) for air passes, containing
at least one heat exchanger (101) for exchanging heat with the air,
a filtering system (1) according to any of the preceding Representative Paragraphs, placed in the flow path (P).

Representative Paragraph 15. A vehicle (200) that has a filtering system (1) according to any of the Representative Paragraphs 1 to 13, in particular with an air conditioner (100) according to Representative Paragraph 14.

1. A filtering system for filtering air, in particular for a vehicle, comprising
a filter for filtering particles out of the air, through which a flow path for the air passes,
an ionizer, which contains an electrode assembly, through which the flow path passes upstream of the filter,
wherein the electrode assembly contains an electrode that has at least one emitter and a counter electrode, between which there is a voltage for generating a corona discharge in the air, when in operation,
wherein the filter contains at least one electrically conductive section and at least one dielectric section, which are arranged successively along the flow path,
with a control unit designed to operate the filtering system successively in a regular operating mode and a reactivation mode,
wherein at least one of the conductive sections, in particular the respective conductive section, is electrically connected to the counter electrode in the reactivation mode, and disconnected therefrom in the regular operating mode.

2. The filtering system according to claim 1, wherein
the filtering system contains a power source that supplies electricity between the electrode and counter electrode,
when the ionizer is in operation, the electrode is connected to a first pole, in particular a negative pole (20), of the power source, and the counter electrode is connected to a second pole a counter-pole (21) of the power source,
the control unit is designed such that in the reactivation mode at least one of the conductive sections is electrically connected to the second pole of the power source, such that the at least one conductive sections and the counter electrode are electrically connected by the power source, and is disconnected from the second pole in the regular operating mode.

3. The filtering system according to claim 1, wherein the at least one conductive section is downstream of at least one static section.

4. The filtering system according to claim 1, wherein the control unit is designed such that the regular operating mode lasts at least ten times as long as the reactivation mode.

5. The filtering system according to claim 1, wherein the control unit is configured to switch between the regular operating mode and the reactivation mode at predefined intervals.

6. The filtering system according to claim 1, wherein
the filtering system contains a sensor system downstream of the filter for determining the air quality,
the control unit is connected to the sensor system and configured to switch from the regular operating mode to the reactivation mode if the value obtained from the sensor system falls below a predefined threshold.

7. The filtering system according to claim 2, wherein
an electric line connects the counter electrode to at least one of the conductive sections, in particular through the second pole,
the filtering system contains a switch for electrically connecting and disconnecting the counter electrode to the filter with the line,
the control unit is designed to switch the switch off in the regular operating mode, and on in the reactivation mode.

8. The filtering system according to claim 1, wherein the electrode has a negative polarity in the regular operating mode and in the reactivation mode, and the counter electrode forms the counter-potential.

9. The filtering system according to claim 1, wherein the at least one emitter and the filter are spaced apart, wherein the distance between the at least one emitter and the filter along the flow path is between 0 mm and 30 mm.

10. The filtering system according to claim 1, wherein the electrode has rods that are spaced apart along the flow path, each of which has at least one emitter that protrudes therefrom.

11. The filtering system according to claim 1, wherein the counter electrode contains an electrically conductive grid (26) through which the flow path passes.

12. The filtering system according to claim 1, wherein the reactivation mode lasts between 1 and 10 minutes.

13. The filtering system according to claim 1, wherein the static section and conductive section each form a layer in the filter.

14. An air conditioner, in particular for a vehicle, through which a flow path for air passes, containing
at least one heat exchanger for exchanging heat with the air,
a filtering system according to claim 1, placed in the flow path.

15. A vehicle that has a filtering system according to claim 1, in particular with an air conditioner the air conditioner comprises
at least one heat exchanger for exchanging heat with the air,
wherein the filtering system placed in the flow path.

16. The filtering system according to claim 9, wherein the distance between the at least one emitter and the filter along the flow path is 7 mm.
